(19) United States
(12) Patent Application Publication
(10) Pub. No.: US 2005/0153168 A1
(43) Pub. Date: Jul. 14, 2005

(54) Co-based perpendicular magnetic recording media

(75) Inventors: Hoon-sang Oh, Seongnam-si (KR); Tae-hyo Lee, Cheonan-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/030,892

(22) Filed: Jan. 10, 2005

(30) Foreign Application Priority Data
Jan. 9, 2004 (KR) 2004-0001409

(51) Int. Cl. G11B 5/68; B32B 1/00

(52) U.S. Cl. 428/694 T; 428/336

(57) ABSTRACT

A perpendicular magnetic recording medium including a Co-based magnetic recording layer, a substrate supporting the magnetic recording layer, and a perpendicular orientation underlayer placed between the magnetic recording layer and the substrate. The perpendicular orientation underlayer is composed of a Ru—Co alloy with 1-65 at. % of Co. The perpendicular magnetic recording medium can achieve good crystallinity and good magnetic characteristics by having the perpendicular orientation underlayer with a small lattice mismatch for the recording layer.

This application claims the benefit of Korean Patent Application No. 10-2004-0001409, filed on Jan. 9, 2004, in the Korean Intellectual Property Office, the disclosure of which is incorporated herein in its entirety by reference.

### BACKGROUND OF THE INVENTION

1. Field of the Invention

Apparatuses consistent with the present invention relate to a Co-based perpendicular magnetic recording medium capable of recording information with a high-density, and more particularly, to a Co-based perpendicular magnetic recording medium capable of ensuring good crystallinity and magnetic characteristics and increasing a recording density even at a shallow thickness of a recording layer.

2. Description of the Related Art

Hard disk drives (HDDs), which are representative magnetic information storage media and lead a rapid increase in recording density, are currently adopting a longitudinal magnetic recording method where a ring type head and longitudinal magnetic recording media are involved. A conventional longitudinal magnetic recording method, however, comes across a limit in increasing the recording density because of the thermal instability of a recording medium, and a new recording method, a perpendicular magnetic recording method, is currently being actively developed since the perpendicular magnetic recording method is expected to increase the recording density further well beyond 200 Gb/in².

In the perpendicular magnetic recording method, unlike a conventional longitudinal magnetic recording method, unit bits which will be recorded in a medium are magnetized in a direction perpendicular to a substrate. The recording density can be further improved by using perpendicular magnetic recording media having the following characteristics:

(1) a high coercive force and a high perpendicular magnetic anisotropic energy constant (Ku>1×10⁶ erg/cc) through ensuring good crystallinity of a recording layer;

(2) small crystal grains; and

(3) a weak exchange coupling between magnetic particles.

Generally, perpendicular magnetic recording media are divided into single magnetic layered magnetic recording media and double magnetic layered magnetic recording media as illustrated in FIGS. 1A and 1B. Single magnetic layered magnetic recording media include a recording layer, which stores magnetic information, and a perpendicular orientation underlayer formed on a substrate before the recording layer is deposited, in order to improve magnetic and crystallographic characteristics of the recording layer. Meanwhile, double magnetic layered magnetic recording media further include a soft magnetic underlayer in addition to the recording layer and the perpendicular orientation underlayer, so as to increase the intensity and spatial change rate of a magnetic field generated by a pole type recording head including an induction coil upon magnetic recording.

Crystallinity and the microstructure of the respective recording layer of the recording media having the structures as described above are significantly affected by crystal structure and the lattice constant of the perpendicular orientation underlayer located below the recording layer.

When the crystallographic structures of a recording layer and a perpendicular orientation layer are totally different or when the lattice mismatch between the recording layer and the perpendicular orientation layer is too large despite their similar crystallographic structures, the so-called initial growth layer, which is crystallographically and magnetically unstable film, is formed at the initial stage of recording layer growth and deteriorates the characteristics of recording layer.

Generally, it is known that as the thickness of a thin film is increased when depositing the thin film via vacuum deposition, the size of crystal grains increases. Since the size of crystal grains should be reduced to achieve a high recording density, the development of a method of fabricating a recording layer with good crystallinity and magnetic characteristics even at a shallow thickness is an essential part in the development of recording media.

Examples of a material used in a perpendicular orientation underlayer of a conventional Co-based perpendicular magnetic recording medium include Ti, Pt, Ru, and the like. The lattice mismatch between each of these materials and CoCrPtB which is a kind of Co-based recording layer is shown in Table 1 below. As indicated, lattice mismatch is greater for Ti, intermediate for Pt, and smaller for Ru.

TABLE 1

| | | | | | | Distance | |
|---|---|---|---|---|---|---|---|
| | | | | | | between | Lattice |
| | | | | | | atoms on CP | mismatch |
| | | | | | | plane | for |
| Material of | Crystal | | | | | (close- packed | CoCrPtB |
| underlayer | structure | a (Å) | b(Å) | c(Å) | d-spacing | plane) | (%) |
| NiFe | FCC | 3.560 | 3.560 | | 2.055 | 2.517 | −2.7 |
| Pd | FCC | 3.891 | 3.891 | | 2.246 | 2.751 | 6.4 |
| Pt | FCC | 3.924 | 3.924 | | 2.266 | 2.775 | 7.3 |
| Au | FCC | 4.078 | 4.078 | | 2.355 | 2.884 | 11.5 |
| Ag | FCC | 4.085 | 4.085 | | 2.359 | 2.889 | 11.7 |
| Co | HCP | 2.507 | 2.507 | 4.070 | 2.035 | 2.507 | −3.1 |
| CoCr₁₆Pt₁₈B₄ | HCP | Recording | | | 2.099 | 2.586 | 0.0 |
| | | Layer | | | | | |
| Ru | HCP | 2.706 | 2.706 | 4.282 | 2.141 | 2.706 | 4.6 |
| Ti | HCP | 2.951 | 2.951 | 1.686 | 2.343 | 2.951 | 14.1 |

Although Co and NiFe have smaller lattice mismatch with CoCrPtB than Ru, they are not suitable to be used as an underlayer because they are ferromagnetic materials. Ferromagnetic underlayer may have an unexpected influence on recording due to the magnetic interaction with recording layer and may increase the media noise during the read/write process.

Ti, which has been widely used to form a perpendicular orientation underlayer, is known to form a thick initial growth layer due to a relatively large difference in a crystal lattice constant between Ti and a Co-based alloy thin film for a perpendicular magnetic recording layer, thereby degrading the orientation characteristics of the perpendicular magnetic recording layer.

Pt has a relatively small difference in the lattice constant from the Co-based perpendicular magnetic recording layer and thus ensures a good perpendicular orientation characteristic. However, it increases the size of crystal grains of a Co-based alloy perpendicular magnetic recording layer (in particular, a Co-based alloy containing 10 or higher at. % of Pt) and significantly increases exchange coupling between magnetic particles, thereby reducing the signal to noise ratio (SNR). The degree to which the use of the Pt underlayer increases the size of crystal grains of the recording layer and the exchange coupling between magnetic particles is closely related to the thickness of the Pt underlayer. When a thick Pt underlayer is used, as described above, the crystallographic perpendicular orientation of the recording layer is very good, and thus a high perpendicular magnetic anisotropic constant Ku and a high coercive force are obtained. However, due to an increase in the size of crystal grains of the underlayer, the size of crystal grains of the perpendicular recording layer also increases and the achievable maximum recording density gets lowered. Meanwhile, when a thin Pt underlayer is used, the size of crystal grains of the perpendicular magnetic recording layer is not greatly increased, but the degree of perpendicular orientation is lower than when a thick Pt underlayer is used, thereby providing a low perpendicular magnetic anisotropic constant Ku and a low coercive force.

Among the nonmagnetic substances, Ru has a very small lattice mismatch for a Co-based alloy and thus is currently widely used as an underlayer of a Co-based perpendicular magnetic recording medium. However, since it still has a lattice mismatch of about 4-5% for a Co-based alloy, an underlayer of another material capable of further reducing lattice mismatch is required.

### SUMMARY OF THE INVENTION

An exemplary embodiment of the present invention provides a perpendicular magnetic recording medium having good crystallinity and magnetic characteristics even at a shallow thickness by using a perpendicular orientation underlayer having a low lattice mismatch for a recording layer.

According to an aspect of the present invention, there is provided a perpendicular magnetic recording medium including a Co-based magnetic recording layer, a substrate supporting the magnetic recording layer, and a perpendicular orientation underlayer placed between the magnetic recording layer and the substrate, in which the perpendicular orientation underlayer is composed of a Ru—Co alloy with 1-65 at. % of Co.

The perpendicular magnetic recording medium may further include a soft magnetic underlayer between the perpendicular orientation underlayer and the substrate.

In the perpendicular magnetic recording medium having soft underlayer below perpendicular orientation underlayer as shown in FIG. 1B, it is desirable to minimize the thickness of perpendicular orientation layer, for example, below 30 nm, without noticeable sacrifice of magnetic and crystallographic orientation properties of recording layer, in order to obtain strong and sharp writing field during the writing process.

According to an exemplary embodiment of the present invention, a perpendicular magnetic recording medium suitable for high density recording is provided by using a RuCo alloy underlayer with a low lattice mismatch for a Co-based recording layer.

### BRIEF DESCRIPTION OF THE DRAWINGS

The above and other aspects of the embodiments of the present invention will become more apparent by describing in detail exemplary embodiments thereof with reference to the attached drawings in which:

FIGS. 1A and 1B are sectional diagrams illustrating the layered structure of conventional single magnetic layered perpendicular magnetic recording media and double magnetic layered perpendicular magnetic recording media, respectively;

FIG. 2 is a phase diagram of a Ru—Co alloy system;

FIG. 3 is a graph of X-ray diffraction patterns of Co-based perpendicular magnetic recording media grown on perpendicular orientation underlayers of various materials;

FIGS. 4A through 4E are graphs illustrating perpendicular magnetic hysteresis curves of Co-based perpendicular magnetic recording media grown on perpendicular orientation underlayers of various materials; and

FIGS. 5A and 5B are graphs illustrating magnetic parameters of Co-based perpendicular magnetic recording media grown on perpendicular orientation underlayers of various materials.

### DETAILED DESCRIPTION OF EXEMPLARY NON-LIMITING EMBODIMENTS OF THE INVENTION

Hereinafter, exemplary embodiments of the present invention will be described in more detail with reference to the attached drawings.

The layered structure of a perpendicular magnetic recording medium of an exemplary embodiment of the present invention is similar to that of a conventional perpendicular magnetic recording medium. However, it is noted that instead of Ti, Pt, and Ru conventionally and mainly used as a material for a perpendicular orientation underlayer, a Ru—Co alloy where Co is added to Ru.

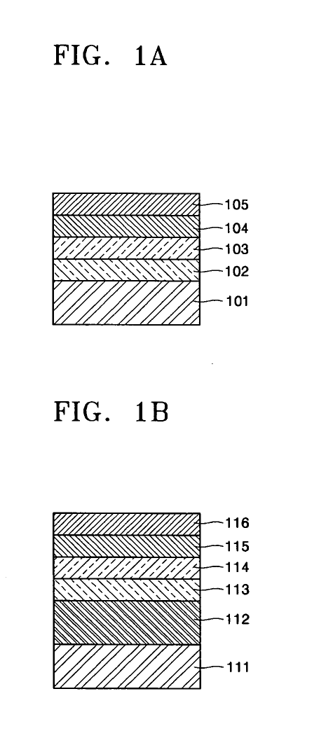

Thus, in the perpendicular magnetic recording medium of an exemplary embodiment of the present invention, as illustrated in FIGS. 1A and 1B, a perpendicular magnetic recording layer 103 (114) is placed on a substrate 101 (111), and a perpendicular orientation underlayer 102 (113) is placed between the perpendicular magnetic recording layer 103 (114) and the substrate 101 (111). In the case of a double magnetic layer structure, a soft magnetic underlayer 112 is further placed between the perpendicular orientation underlayer 113 and the substrate 111. A protection layer 104 (115) may be placed on the perpendicular magnetic recording layer 103 (114) so as to protect the recording layer, and a lubricating layer 105 (116) may further be placed on the protection layer 104 (115) to reduce abrasion of a magnetic head of a hard disk drive (HDD) and the protection layer 104 (115) due to collision and sliding between the protection layer 104 (115) and the magnetic head.

A Co-based alloy perpendicular magnetic recording layer in the perpendicular magnetic recording medium of an exemplary embodiment of the present invention is composed of an alloy represented by the following formula (1).
Co_{100-(x+y+z)}CrₓPt_{y}X_{z} (1)
where,

X is any one selected from the group consisting of Nb, B, Ta, 0, and SiO₂,
x is 5-25 at. %;
y is 10-25 at. %; and
z is 0-10 at. % for X=Nb, B, Ta, O and z is 0-15 mol % for X=SiO₂ .

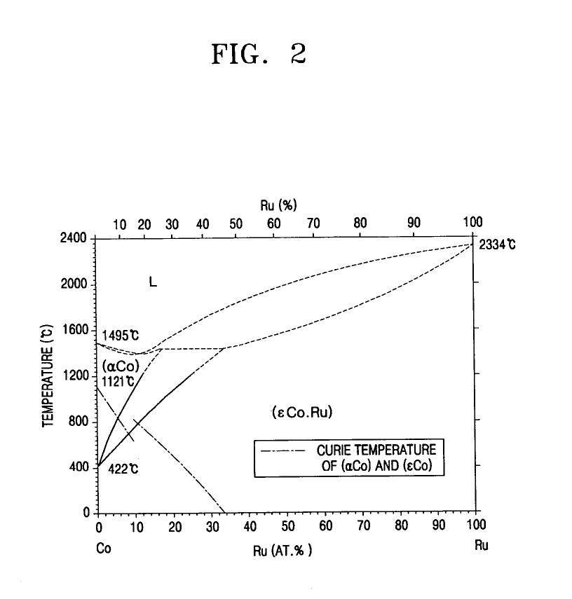

A perpendicular orientation underlayer of Ru—Co is placed below the recording layer. It is known that both Ru and Co have a hexagonal close packed (HCP) lattice structure. Also, as seen from the graph of FIG. 2 illustrating a phase diagram of a Ru—Co alloy system, Ru and Co form an isomorphous solid solution throughout overall composition, and thus it is possible to add Co uniformly to Ru. Such addition of Co may change the lattice constant of Ru to be close to the lattice constant of Co. That is, since the addition of Co may reduce the lattice constant of Ru, a Ru—Co alloy having a substantially identical lattice constant to the lattice constant of a recording layer may be fabricated by properly controlling the content of Co according to the composition and lattice constant of CoCrPtX selected as a recording layer. Therefore, it is possible to fabricate Ru—Co alloy underlayer which has a substantially identical lattice constant to the lattice constant of the recording layer, and thus a recording layer with good crystallinity can grow from the initial stage of growth.

The amount of Co added to Ru may be 1-65 at. %. When the amount of Co is less than 1 at. %, the effect of reducing the lattice mismatch of Ru is insignificant, and when the amount of Co is greater than 65 at. %, the curie temperature of Ru—Co rises above room temperature, thereby shows ferromagnetic property at room temperature. If the underlayer is ferromagnetic, the recording layer and the underlayer can interact and have an unexpected influence on the recording and reproducing properties, which generally induces the increase of media noise.

As describe above, a difference in the lattice constant between the Ru—Co underlayer and the CoCrPtX recording layer can be within ±4% by controlling the amount of Co in the Ru—Co alloy.

In a single magnetic layered perpendicular magnetic recording medium, an underlayer composed of Ta, Pt, Pd, Ti, Cr, or an alloy thereof may further be included below the Ru—Co alloy underlayer to planarize the substrate. In other words, this underlayer acts as a smooth layer providing an even surface so that a thin layer which will be subsequently deposited can be stably grown by covering surface defects of the substrate.

In a double magnetic layered perpendicular magnetic recording medium, a soft magnetic underlayer may further be included below the perpendicular orientation underlayer of the Ru—Co alloy. When performing a perpendicular magnetic recording using a single pole head, the soft magnetic underlayer forms a magnetic path of a perpendicular magnetic field generated by the single pole head, thus enabling information to be recorded on the perpendicular magnetic recording layer. Examples of a material for the soft magnetic underlayer include Fe-based alloys such as NiFe, NiFeNb, NiFeCr, FeTaC, FeC, FeTaN, and FeAlSi, and Co-based alloys such as CoZrNb, CoTaZr, and CoFe.

The perpendicular magnetic recording medium may further include a protection layer for protecting the recording layer and a lubricating layer placed on the protection layer.

In the perpendicular magnetic recording medium, particularly in a double magnetic layered perpendicular magnetic recording medium including the soft magnetic underlayer, the total thickness of the underlayers should be minimized, preferably below 30 nm. When the underlayer placed between the recording layer and the soft magnetic underlayer in the double magnetic layered perpendicular magnetic recording medium is too thick, the distance between a pole type recording head and the soft magnetic underlayer is too great. In this case, a function of the soft magnetic underlayer improving field strength and field gradient may not sufficiently be utilized, which is not preferred in achieving ultrahigh density recording.

Exemplary embodiments of the present invention will be described in greater detail with reference to the following examples. The following examples are for illustrative purposes and are not intended to limit the scope of the invention.

### EXAMPLE 1

Ta was deposited as an underlayer for planarizing a substrate, to a thickness of 5 nm on a commercially available glass substrate with a diameter of 2.5 inches, and then a Ru—Co underlayer with 14 at. % of Co was laminated thereon to a thickness of 15 nm. Thereafter, a magnetic layer of a Co₆₂Cr₁₆Pt₁₈B₄ alloy was deposited to a thickness of 17 nm on the Ru—Co underlayer to obtain a perpendicular magnetic recording medium.

### EXAMPLE 2

Ta was deposited as an underlayer for planarizing a substrate, to a thickness of 5 nm on a commercially available glass substrate with a diameter of 2.5 inches, and then a Ru—Co underlayer with 25 at. % of Co was laminated thereon to a thickness of 15 nm. Thereafter, a magnetic layer of a Co₆₂Cr₁₆Pt₁₈B₄ alloy was deposited to a thickness of 17 nm on the Ru—Co underlayer to obtain a perpendicular magnetic recording medium.

### COMPARATIVE EXAMPLE 1

A Ti underlayer was deposited to a thickness of 70 nm on a commercially available glass substrate with a diameter of 2.5 inches, and then a magnetic layer of a Co₆₂Cr₁₆Pt₁₈B₄ alloy was deposited to a thickness of 30 nm thereon to obtain a perpendicular magnetic recording medium.

### COMPARATIVE EXAMPLE 2

A perpendicular magnetic recording medium was fabricated in the same manner as in Comparative Example 1 except that a Pt underlayer was deposited to a thickness of 40 nm.

### COMPARATIVE EXAMPLE 3

Ta was deposited as an underlayer for planarizing a substrate, to a thickness of 5 nm on a commercially available glass substrate with a diameter of 2.5 inches, and then a magnetic layer of a Co₆₂Cr₁₆Pt₁₈B₄ alloy was deposited to a thickness of 17 nm thereon to obtain a perpendicular magnetic recording medium.

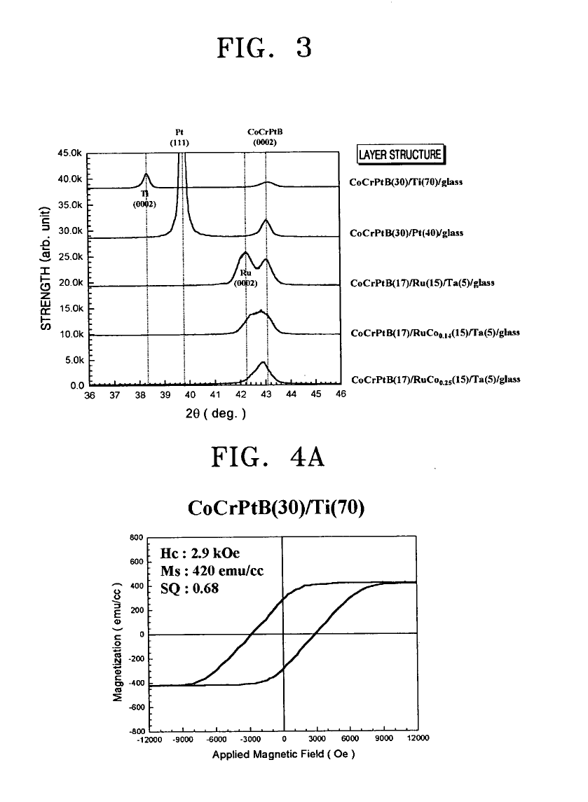

X-ray diffraction analysis was performed on the perpendicular magnetic recording media prepared above, and the results are illustrated in FIG. 3.

Referring to FIG. 3, as the lattice constant of the underlayer is close to the lattice constant of CoCrPtB, an X-ray diffraction line of the underlayer is close to an x-ray diffraction line of the CoCrPtB. In the case of Examples 1 and 2 using the Ru—Co underlayer, two diffraction lines overlap due to a very small difference in the lattice constant between the underlayer and recording layer and appear as if they are one diffraction line. Also, as the amount of Co added to Ru is increased from 14 at. % to 25 at. %, the lattice constant of Ru—Co increases and becomes closer to the lattice constant of the recording layer.

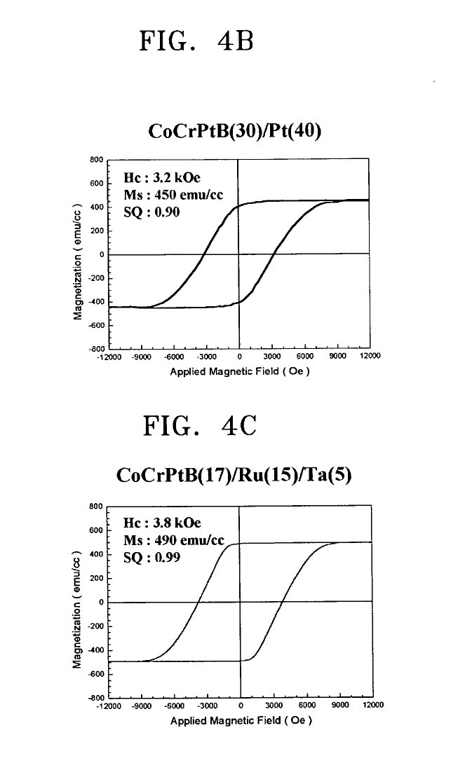

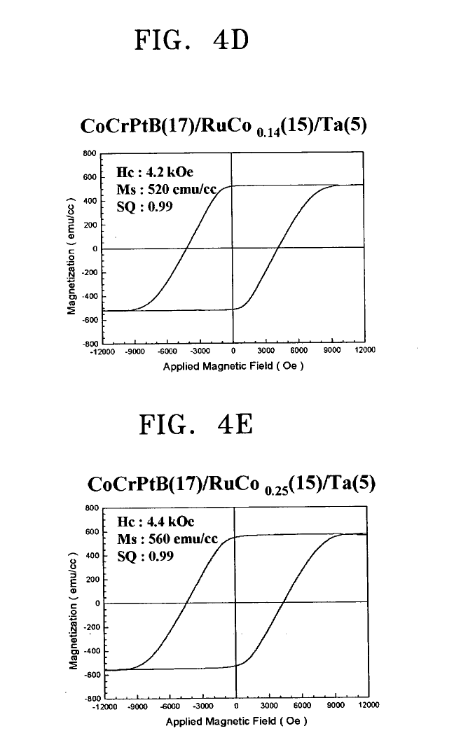

Also, to investigate the magnetic characteristics of the perpendicular magnetic recording media prepared in the above Examples and Comparative Examples, magnetic hysteresis curves are illustrated in FIGS. 4A through 4E. Referring to FIGS. 4A through 4E, when a Ti underlayer having a lattice constant that differs greatest from the lattice constant of the recording layer was used (Comparative Example 1), a low squareness of about 0.7 and a low coercive force of about 2.9 kOe were obtained. However, as the lattice constant of the underlayer becomes closer to the lattice constant of the recording layer, squareness and coercive force are increased. As a result, when Ru—Co with 25 at. % of Co was used as an underlayer (Example 1), a high squareness of 0.99 and a large coercive force of 4.4 kOe were obtained.

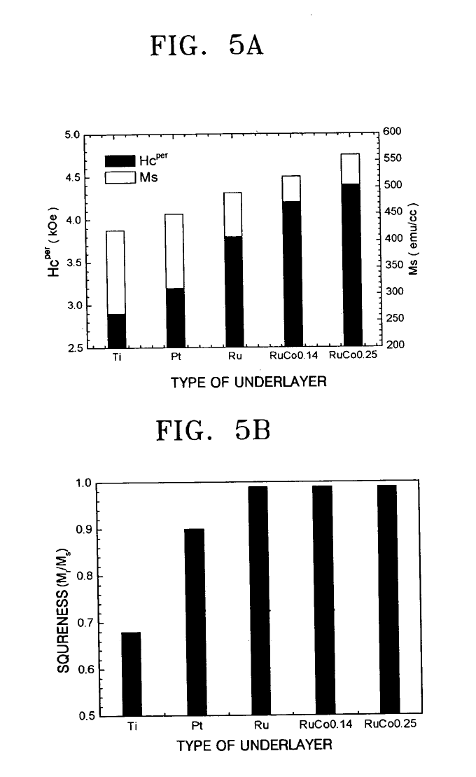

In FIGS. 5A and 5B, magnetic characteristics parameters of the perpendicular magnetic recording medium prepared in the above Examples and Comparative Examples are comparatively illustrated. FIG. 5A is a graph illustrating the coercive force and FIG. 5B is a graph illustrating the squareness. As seen from FIGS. 5A and 5B, as the lattice constant of the underlayer is close to the lattice constant of the recording layer, the saturation magnetization value as well as the coercive force and squareness increases. This is because the thickness of an initial growth layer decreased or the initial growth layer is eliminated as the lattice mismatch between the underlayer and the recording layer is reduced, and thus the proportion of a magnetically unstable layer in the whole recording layer is reduced. Thus, better crystallographical and magnetic characteristics can be obtained even when a recording layer is formed thinner than a recording layer of a conventional recording medium, by controlling the lattice constant of an underlayer to be close to the lattice constant of the recording layer.

According to an exemplary embodiment of the present invention, a perpendicular magnetic recording layer having no or negligibly thin initial growth layer is fabricated by using a Ru—Co alloy underlayer to reduce the lattice mismatch. Thus, all of high thermal stability, high density recording property, and good SNR characteristic of the perpendicular magnetic recording layer can be ensured.

While embodiments of the present invention have been particularly shown and described with reference to exemplary embodiments thereof, it will be understood by those of ordinary skill in the art that various changes in form and details may be made therein without departing from the spirit and scope of the present invention as defined by the following claims.

1. A perpendicular magnetic recording medium comprising:
a Co-based magnetic recording layer,
a substrate supporting the magnetic recording layer, and
a perpendicular orientation underlayer placed between the magnetic recording layer and the substrate,
wherein the perpendicular orientation underlayer is composed of a Ru—Co alloy with 1-65 at. % of Co.

2. The perpendicular magnetic recording medium of claim 1, wherein the Co-based magnetic recording layer is composed of an alloy represented by the following formula 1:
Co_{100-(x+y+z)}CrₓPt_{y}X_{z}
where,
X comprises any one of Nb, B, Ta, O, and SiO₂;
x is 5-25 at. %;
y is 10-25 at. %; and
z is 0-10 at. % for X=Nb, B, Ta, O and z is 0-15 mol % for X=SiO₂.

3. The perpendicular magnetic recording medium of claim 2, wherein a difference in a lattice constant of the Co-based magnetic recording layer and a lattice constant of the Ru—Co alloy underlayer is within ±4%.

4. The perpendicular magnetic recording medium of claim 1, wherein a soft magnetic underlayer is disposed between the perpendicular orientation underlayer and the substrate.

5. The perpendicular magnetic recording medium of claim 4, wherein a nonmagnetic underlayer composed of Ta, Pt, Pd, Ti, Cr, or an alloy thereof is disposed between the perpendicular orientation underlayer and the substrate or between the perpendicular orientation underlayer and the soft magnetic underlayer.

6. The perpendicular magnetic recording medium of claim 1, wherein the thickness of the perpendicular orientation underlayer is 30 nm or less.

7. The perpendicular magnetic recording medium of claim 2, wherein the thickness of the perpendicular orientation underlayer is 30 nm or less.

8. The perpendicular magnetic recording medium of claim 3, wherein the thickness of the perpendicular orientation underlayer is 30 nm or less.

9. The perpendicular magnetic recording medium of claim 4, wherein the total thickness of the perpendicular orientation underlayer and the soft magnetic underlayer is 30 nm or less.

10. The perpendicular magnetic recording medium of claim 5, wherein the total thickness of the perpendicular orientation underlayer and the soft magnetic underlayer is 30 nm or less.

11. The perpendicular magnetic recording medium of claim 2, wherein X is any one selected from the group consisting of Nb, B, Ta, O, and SiO₂.
